(19) United States
(12) Patent Application Publication
(10) Pub. No.: US 2003/0016440 A1
(43) Pub. Date: Jan. 23, 2003

(54) Optical fiber oven

(75) Inventors: Dany M. Zeidan, Howell, NJ (US); Jeffrey Eisenmann, Howell, NJ (US)

Correspondence Address: John P. Maldjian, TyCom (US) Inc., Rm 2B 106, 250 Industrial Way West, Eatontown, NJ, 07724, US

(73) Assignee: Terra Worx, Inc.

(21) Appl. No.: 09/906,964

(22) Filed: Jul. 17, 2001

(51) Int. Cl. H01S 3/00

(52) U.S. Cl. 359/341.1

(57) ABSTRACT

An optical fiber oven encloses optical fibers, such as erbium doped fibers, and maintains an optimal temperature range for the fibers. The optical fiber oven includes a housing having fiber entrance holes and fiber exit holes allowing the fiber to enter and exit the housing. The fibers are positioned around a fiber hub within the housing to maintain the minimum bend radius of the optic fiber. A heating element and heat regulation device are mounted within the housing to maintain the optimal temperature.

### TECHNICAL FIELD

The present invention relates to fiber optic systems and more particularly, to an optical fiber oven used in an optical amplifier, such as an erbium doped fiber amplifier (EDFA), to maintain fibers within a desired temperature range.

### BACKGROUND INFORMATION

Transmitting optical signals over long distances requires amplification of the optical signals to prevent degradation. Earlier fiber optic systems converted optical signals into the electrical domain, amplified and reshaped the electrical signal, and then converted the electrical signal back into an optical signal. In multi-wavelength systems, each wavelength must be separately converted, requiring a large amount of equipment.

Optical amplifiers allow the optical signals to be amplified without having to convert to the electrical domain. Optical amplifiers, such as erbium doped fiber amplifiers (EDFAs), are capable of amplifying multiple wavelengths independently in a single unit. Increasing the number of channels on a single optical fiber using an optical amplifier has significantly increased the bandwidth of fiber optic systems. The growth in the bandwidth of optical communication systems has also led to a demand for more complex functionality in optical networks. To satisfy this demand, devices have become increasingly smaller and more compact, while integrating multiple functions into a single device.

In EDFA systems, bend losses are proportional to the bend radius and a minimum bend radius of erbium doped fiber should be maintained for optimum performance. The minimum bend radius must therefore be taken into consideration when developing smaller and more compact optical devices. Another consideration in EDFA systems is that erbium fibers should be maintained within a certain temperature range for optimal performance.

Accordingly, there is a need for a device capable of maintaining the temperature of optical fiber within a predetermined range while accommodating and managing the fibers to maintain a minimum bend radius.

### SUMMARY

In accordance with one aspect of the present invention, an optical fiber oven maintains optical fiber within a predetermined temperature range. The optical fiber oven comprises a housing for enclosing a portion of optical fiber. Fiber entrance holes and fiber exit holes within the housing allow the optical fiber to enter and exit the housing. A fiber hub within the housing supports coils of the optical fiber wrapped around the fiber hub. The optical fiber oven also comprises a heating element within the housing and a heat regulation device within the housing for regulating the heating element to maintain the predetermined temperature range.

According to one embodiment, the optical fiber oven is used with erbium-doped fibers and the fiber hub is shaped to maintain a minimum bend radius of the erbium-doped fibers for optimum performance. The fiber hub is preferably substantially cylindrically shaped, and the heating element is preferably circular shaped and mounted to the fiber hub. This location of the heating element permits substantially even heat distribution. A cable access hole is preferably located in a bottom of the housing, for allowing at least one cable to enter the housing without interfering with the fiber coils.

In accordance with another aspect of the invention, a housing for an optical fiber oven comprises a housing base portion having at least one flat side, a rounded side, and first and second flanges around at least the rounded side forming an exterior fiber routing groove. A substantially cylindrical fiber hub extends from a bottom of the housing base portion, for supporting optical fibers. A heating element mounting surface is located on the fiber hub and fiber spacers are located around the fiber hub, for spacing and securing the optical fibers. Fiber strain relief boots are connected to the flat side, for allowing optical fiber to enter and exit the housing. A lid covers the housing base portion. The housing is preferably made of a thermally insulated, static dissipative, and non-flammable material, such as anti-static polycarbonate.

### BRIEF DESCRIPTION OF THE DRAWINGS

These and other features and advantages of the present invention will be better understood by reading the following detailed description, taken together with the drawings wherein:

FIG. 1 is a top perspective view of an optical fiber oven, according to one embodiment of the present invention;

FIG. 2 is a bottom perspective view of the optical fiber oven shown in FIG. 1;

FIG. 3 is an exploded view of the optical fiber oven, according to one embodiment of the present invention;

FIG. 4 is a top perspective view of a housing base portion of the optical fiber oven, according to one embodiment of the present invention; and

FIG. 5 is a cross-sectional top view of the optical fiber oven mounted to a printed wiring board (PWB).

### DETAILED DESCRIPTION OF THE PREFERRED EMBODIMENTS

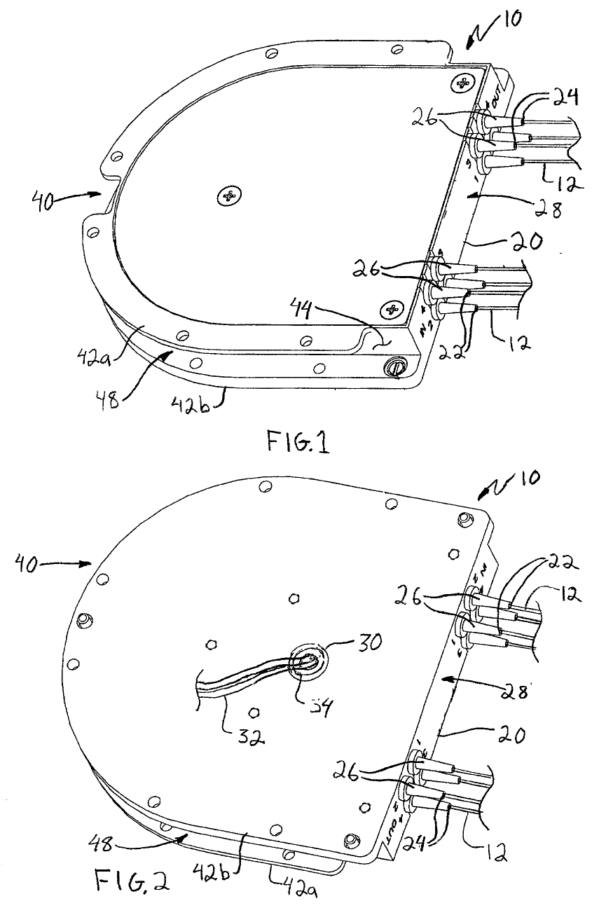

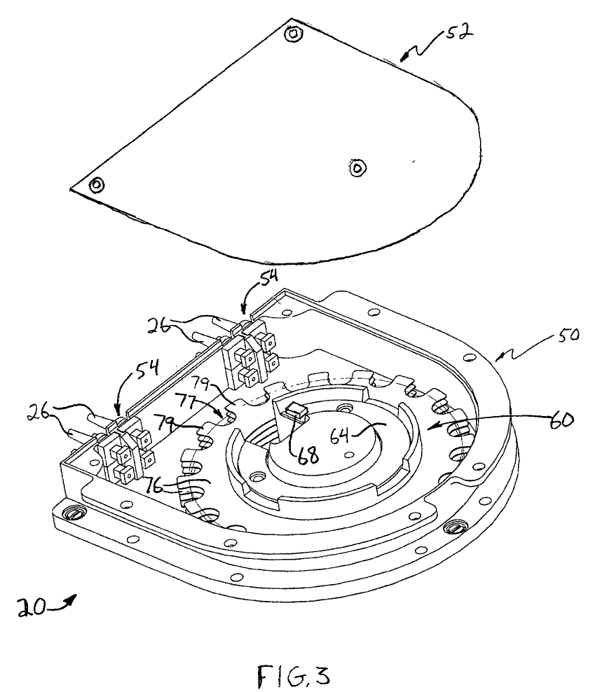

Referring to FIGS. 1 and 2, an optical fiber oven 10 encloses and heats a section of optical fibers 12 within an optical amplifier (not shown). In the exemplary embodiment, the optical fiber 12 is a rare earth-doped fiber, such as erbium-doped fiber, and the optical fiber oven 10 is an erbium doped fiber module (EDFM) oven used in an erbium doped fiber amplifier (EDFA). The optical fiber oven 10 can also be used with other types of optical fiber in other types of optical equipment.

The optical fiber oven 10 includes a housing 20 with fiber entrance holes 22 allowing fibers to pass in to the housing 20 and fiber exit holes 24 allowing the fibers to pass out of the housing 20. In one preferred embodiment, the entrance holes 22 and exit holes 24 are located within fiber strain relief boots 26 extending from a flat side 28 of the housing 20. Although the exemplary embodiment shows four optical fibers 12, the optical fiber oven 10 can be used with more or less optical fibers 12. A cable access hole 30 is located on at least one side of the housing 20 to allow control and power cables 32 to enter and exit the housing 20. A strain relief device 34, such as a bushing, is preferably used within the cable access hole 30 to maintain the integrity of the power and control cables 32.

According to one preferred embodiment, the housing 20 includes at least one rounded side 40 with flanges 42a, 42b and an exterior fiber routing surface 44, defining an exterior fiber routing groove or channel 48. The housing 20 is preferably designed to have a low profile that permits mounting directly to a printed wiring board (PWB) (not shown) or mounting to standoffs on a PWB allowing circuit layout beneath the housing 20. When mounted on the PWB, the exterior fiber routing surface 44 can be used to take up excess slack, manage and/or change direction of excess fiber external to the oven 10. The exterior fiber routing surface 44 is preferably shaped to maintain the minimum bend radius of the external optical fiber being managed. One or both of the flanges 42a, 42b can include tie down holes 46 for wrapping or safely securing the externally managed optical fiber.

Referring to FIGS. 3-5, the inside of the optical fiber oven 10 is described. In the exemplary embodiment, the housing 20 is formed by a housing base portion 50 and a lid 52 removably attached to the housing base portion 50 (FIG. 3). The fiber strain relief boots 26 are preferably removably attached to the housing base portion 50, for example, by sliding into slots 54 within the flat side 28 to assist in assembly and repair. The fiber strain relief boots 26 can be made of non-flammable rubber or another suitable material. One type of fiber strain relief boot that can be used is available from JDS Uniphase.

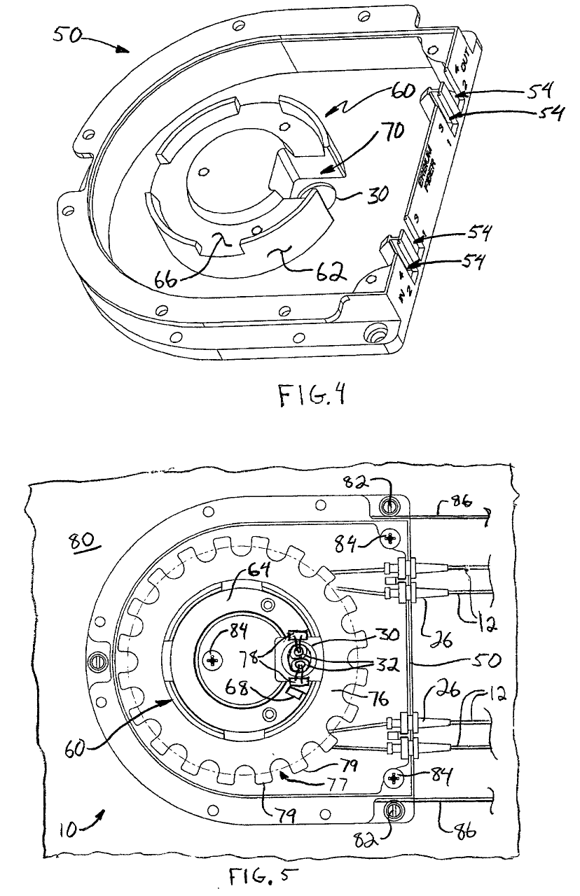

The optical fiber oven 10 includes a fiber hub 60 (FIG. 4) inside of the housing 20. The fiber hub 60 includes a fiber hub surface 62 around which the optical fiber 12 is coiled. In one preferred embodiment the fiber hub 60 is a generally cylindrical shaped hub extending from a bottom surface of the housing base portion 50. The fiber hub surface 62 preferably has a generally circular shape sized to maintain the minimum bend radius that optical fibers 12 must keep for optimum performance. In one example, the minimum bend radius of erbium doped fiber is about 1.0″ on average.

Although the exemplary embodiment shows a fiber hub 60 with a generally cylindrical shape centrally located within the housing 20, other configurations and locations are contemplated. According to one alternative, multiple fiber hubs 60 can be located within a single housing 20.

The optical fiber oven 10 also includes a heating element 64 within the housing 20. A heat regulation device 68, such as a thermistor, is connected to the heating element 64 to regulate the heating element 64 and maintain a substantially constant temperature in a range that will maximize the performance of the optical fiber 12. In one example using erbium-doped fiber, the heat regulation device 68 maintains a substantially constant temperature of about 45° C. ±1° C. This elevated temperature increases the molecular movement within the erbium, thereby increasing the transmission rate of the fiber and consistently maintaining it. In other examples, the optimal temperature range may be different.

In one preferred embodiment, the heating element 64 preferably has a generally flat “C” shape and is located on a heating element support surface 66 on the fiber hub 60. One type of heating element 64 and heat regulation device 68 that can be used is available from Minco Products, Inc. In this configuration, the heat is radiated outwardly to the optical fiber 12 coiled on the fiber hub 60, thereby permitting substantially even heat distribution. Other configurations are also contemplated. For example, the heating element 64 can be positioned in other locations (e.g., above or below the fibers) or multiple heating elements can be used. The heating element 64 may also be wrapped around surface 62 for even distribution of heat.

The power and control cable access hole 30 is preferably located such that the cables 32 are attached to the heating element 64 without interfering with the optical fibers 12 within the housing. In the exemplary embodiment, the cable access hole 30 extends through a section 70 of the fiber hub 60.

The housing 20 is preferably made of a material having insulating, static dissipative, and non-flammable properties, such as anti-static polycarbonate. This helps to maintain the optimal temperature within the housing 20 and prevents the radiant heat from the optical fiber oven 10 from affecting the interior temperature of the optical amplifier. The preferred material of the housing 20 (e.g., polycarbonate) is also non-flammable for fire safety and static dissipative to avoid upsetting sensitive electronic components in the vicinity of the housing 20.

In one preferred embodiment, fiber spacers 76 are positioned around the fiber hub 60 and preferably press-fit around the fiber hub 60. The fiber spacers 76 preferably space each coil of optical fiber 12 from an adjacent coil of optical fiber 12 and insure that each coil is retained in place. In one example, the fiber spacers 76 can be made of polyester. The fiber spacers 76 preferably include openings 77 between teeth 79 to allow heat spreading down to the fiber coil (s). The openings 77 and teeth 79 also allow for flexibility where fiber coil ties may protrude between teeth 79 or push up a single tooth 79 without affecting the rest of the spacers 76. Although the exemplary embodiment shows four fiber spacers 76, the number of fiber spacers 76 can vary, for example, depending upon the number of optical fibers 12. The height of the housing 20 also varies depending upon the number of optical fibers 12.

According to one method of assembling and using the exemplary optical fiber oven 10, the heating element 64 and the heat regulation device 68 are attached to the fiber hub 60 within the housing base portion 50. Connectors 78 at the ends of the cables 32 are run through the access hole 30 and connected to the heating element 64 and/or the heat regulation device 68. The housing base portion 50 is then attached to a PWB 80, such as an EDFA board, for example, using screws 82. The screws 82 are preferably captivated to assist in the assembly process. The fiber strain relief boots 26 are then positioned over the ends of the optical fiber 12, for example, over the ends of four erbium fiber coils. The fiber coils are placed around the fiber hub 60 with fiber spacers 76 positioned between each coil. The fiber strain relief boots 26 are then positioned within the slots 54 in the housing base portion 50, and the lid 52 is attached over the base portion 50, for example, using screws 84. External fiber 86 can then be routed around the housing base portion 50.

Accordingly, the optical fiber oven 10 maintains optical fiber, such as erbium-doped fiber, at an optimal temperature range in a self-contained housing. The optical fiber oven 10 also provides internal and external fiber management, for example, to maintain the minimum bend radius of the optical fiber and/or change direction of fiber routing.

Modifications and substitutions by one of ordinary skill in the art are considered to be within the scope of the present invention, which is not to be limited except by the following claims.

The invention claimed is:

1. An optical fiber oven for maintaining optical fiber within a predetermined temperature range, said optical fiber oven comprising:
a housing for enclosing a portion of optical fiber;
fiber entrance holes and fiber exit holes within said housing, for allowing said optical fiber to enter and exit said housing;
a fiber hub within said housing, for supporting coils of said optical fiber wrapped around said fiber hub;
a heating element within said housing; and
a heat regulation device within said housing for regulating said heating element to maintain said predetermined temperature range.

2. The optical fiber oven of claim 1 wherein said housing includes at least one rounded side providing an exterior fiber routing surface.

3. The optical fiber oven of claim 2 further comprising flanges around said rounded side forming an exterior fiber routing groove.

4. The optical fiber oven of claim 3 further comprising tie down holes in said flanges.

5. The optical fiber oven of claim 2 wherein said housing includes at least one flat side having said fiber entrance holes and said fiber exit holes.

6. The optical fiber oven of claim 5 further including fiber strain relief boots mounted in said flat side of said housing, wherein said fiber strain relief boots include said fiber entrance holes and said fiber exit holes.

7. The optical fiber oven of claim 1 further including fiber strain relief boots mounted in said housing, wherein said fiber strain relief boots include said fiber entrance holes and said fiber exit holes.

8. The optical fiber oven of claim 1 wherein said fiber hub is shaped to maintain a minimum bend radius of erbium doped fibers for optimum performance.

9. The optical fiber oven of claim 1 wherein said fiber hub is substantially cylindrically shaped.

10. The optical fiber oven of claim 1 wherein said heating element is mounted on said fiber hub.

11. The optical fiber oven of claim 10 wherein said heating element is substantially circular shaped.

12. The optical fiber oven of claim 10 wherein said temperature regulation device is mounted on said fiber hub.

13. The optical fiber oven of claim 1 wherein said housing includes a housing base portion and a lid covering said housing base portion.

14. The optical fiber oven of claim 1 wherein said temperature regulation device includes a thermistor.

15. The optical fiber oven of claim 1 further comprising fiber spacers around said fiber hub, for spacing and supporting said coils of optical fiber.

16. The optical fiber oven of claim 1 further comprising a cable access hole in a bottom of said housing, for allowing at least one cable to enter said housing.

17. The optical fiber oven of claim 1 wherein said housing is made of a thermally insulated material.

18. The optical fiber oven of claim 14 wherein said thermally insulated material is a polycarbonate.

19. An erbium doped fiber module (EDFM) oven for maintaining erbium doped optical fibers at a predetermined temperature range, said erbium doped fiber module oven comprising:
a housing;
fiber entrance holes and fiber exit holes within said housing, for allowing optical fiber to enter and exit said housing;
a fiber hub within said housing, for supporting coils of said erbium doped optical fibers, wherein said fiber hub is shaped to maintain a minimum bend radius of said erbium doped optical fibers for optimum performance;
a heating element within said housing; and
a heat regulation device within said housing for regulating said heating element to maintain said predetermined temperature range.

20. The EDFM oven of claim 19 wherein said predetermined temperature range is within a range of 45° C.

21. The EDFM oven of claim 19 wherein said housing includes at least one rounded side providing an exterior fiber routing surface.

22. The EDFM oven of claim 21 further comprising flanges around said rounded side forming an exterior fiber routing groove.

23. The EDFM oven of claim 21 wherein said housing includes at least one flat side having said fiber entrance holes and said fiber exit holes.

24. The EDFM oven of claim 19 further including fiber strain relief boots mounted in said flat side of said housing, wherein said fiber strain relief boots include said fiber entrance holes and said fiber exit holes.

25. The EDFM oven of claim 19 wherein said fiber hub is substantially cylindrically shaped.

26. The EDFM oven of claim 19 wherein said heating element is mounted on said fiber hub.

27. The EDFM oven of claim 25 wherein said heating element is substantially circular shaped.

28. The EDFM oven of claim 19 further comprising fiber spacers around said fiber hub, for spacing said coils of erbium doped fiber.

29. The EDFM oven of claim 19 further comprising a cable access hole in a bottom of said housing, for allowing at least one cable to enter said housing.

30. A housing for an optical fiber oven, said housing comprising:
a housing base portion having at least one flat side, a rounded side, and first and second flanges around at least said rounded side forming an exterior fiber routing surface;
a substantially cylindrical fiber hub extending from a bottom of said housing base portion, for supporting optical fibers;
a heating element mounting surface located on said fiber hub;
fiber spacers located around said fiber hub, for spacing said optical fibers;
fiber strain relief boots connected to said flat side, for allowing optical fiber to enter and exit said housing; and
a lid covering said housing base portion.
